(19) United States
(12) Patent Application Publication
(10) Pub. No.: US 2026/0109299 A1
(43) Pub. Date: Apr. 23, 2026

(54) VEHICLE SHELTER SYSTEM AND SHELTER PROVIDING METHOD

(71) Applicant: Ford Global Technologies, LLC, Dearborn, MI (US)

(72) Inventors: Jesus Guadalupe Castillo Maldonado, Ciudad Juarez (MX); Norma Sanchez Palomino, Mexico City (MX)

(21) Appl. No.: 18/922,780

(22) Filed: Oct. 22, 2024

(51) Int. Cl. B60R 9/045; B60P 3/38; E04H 15/06

(52) U.S. Cl. CPC B60R 9/045; B60P 3/38; E04H 15/06

(57) ABSTRACT

A shelter system for a vehicle includes a roof rack assembly having a fixed platform and an extendable platform. The extendable platform is configured to transition back-and-forth between a retracted position relative to the fixed platform and an extended position relative to the fixed platform. The extendable platform projects outward away from a vehicle roof when the extendable platform is in extended position. A tent covers the roof rack assembly when the extendable platform is in the extended position.

### TECHNICAL FIELD

This disclosure is directed toward a shelter system that can be used with a vehicle and, more particularly, to a shelter system utilizing a roof rack of a vehicle.

### BACKGROUND

Many vehicles utilize roof racks to carry cargo. The roof racks of some vehicles can move to an expanded position. Tents can cover the roof racks in the expanded position. In the past, relatively complex mechanisms have been used to facilitate expansion of a roof rack.

### SUMMARY

In some aspects, the techniques described herein relate to a shelter system for a vehicle, including: a roof rack assembly having a fixed platform and an extendable platform, the extendable platform configured to transition back-and-forth between a retracted position relative to the fixed platform and an extended position relative to the fixed platform, the extendable platform projecting outward away from a vehicle roof when the extendable platform is in extended position; and a tent that covers the roof rack assembly when the extendable platform is in the extended position.

In some aspects, the techniques described herein relate to a shelter system, wherein the extendable platform projects outward past a side of a vehicle when the extendable platform is in the extended position.

In some aspects, the techniques described herein relate to a shelter system, wherein the fixed platform includes a plurality of fixed platform slats, wherein the extendable platform includes a plurality of extendable platform slats, the plurality of fixed platform slats and the plurality of extendable platform slats alternate along a longitudinal axis of the roof rack assembly when the extendable platform is in the retracted position.

In some aspects, the techniques described herein relate to a shelter system, wherein the extendable platform slats extend outward from between adjacent fixed platform slats within the plurality of fixed platform slats when the extendable platform is in the extended position.

In some aspects, the techniques described herein relate to a shelter system, wherein the extendable platform projects outward past a perimeter of a roof of a vehicle when the extendable platform is in the extended position.

In some aspects, the techniques described herein relate to a shelter system, wherein the plurality of fixed platform slats span between a first fixed platform siderail of the roof rack assembly and a second fixed platform siderail of the roof rack assembly, wherein the plurality of extendable platform slats span between a first extendable platform siderail and a second extendable platform siderail, wherein the first and second extendable platform siderails move with the plurality of extendable platform slats back-and-forth between the retracted position and the extended position.

In some aspects, the techniques described herein relate to a shelter system, wherein the plurality of extendable platform slats are each received within a corresponding aperture of the first fixed platform siderail and are configured to slide within the apertures relative to the first fixed platform siderail when the extendable platform is transitioned back-and-forth between the retracted position and the extended position.

In some aspects, the techniques described herein relate to a shelter system, wherein the first fixed platform siderail is on a driver side of the roof rack assembly and the second fixed platform siderail is on a passenger side of the roof rack assembly.

In some aspects, the techniques described herein relate to a shelter system, further including a first fixed platform telescoping rail, a second fixed platform telescoping rail, a first extendable platform telescoping rail, and a second extendable platform telescoping rail, the first fixed platform telescoping rail spanning between the first and the second fixed platform siderails on a first side of the roof rack assembly, the second fixed platform telescoping rail spanning between the first and the second fixed platform siderails on an opposite second side of the roof rack assembly, the first extendable platform telescoping rail spanning between the first and the second extendable platform siderails on the first side of the roof rack assembly, the second extendable platform telescoping rail spanning between the first and the second extendable platform siderails on the second side of the roof rack assembly, the first extendable platform telescoping rail received within the first fixed platform telescoping rail and configured to extend and retract relative to the first fixed platform telescoping rail when the extendable platform is transitioned back-and-forth between the retracted position and the extended position, the second extendable platform telescoping rail received within the second fixed platform telescoping rail and configured to extend and retract relative to the second fixed platform telescoping rail when the extendable platform is transitioned back-and-forth between the retracted position and the extended position.

In some aspects, the techniques described herein relate to a shelter system, wherein the plurality of fixed platform slats and the plurality of extendable platform slats are configured to directly support a user positioned within the tent when the extendable platform is in the extended position.

In some aspects, the techniques described herein relate to a shelter system, further including a support structure attachable to the extendable platform and configured to extend from a surface to the extendable platform to support the extendable platform when the extendable platform is in the extended position.

In some aspects, the techniques described herein relate to a shelter system, wherein the support structure is a ladder.

In some aspects, the techniques described herein relate to a shelter providing method, including: transitioning an extendable platform of a roof rack assembly from a retracted position to an extended position relative to a fixed platform of the roof rack assembly, the extendable platform overhanging a vehicle roof when in the extended position; and positioning a tent on the roof rack assembly when the extendable platform is in the extended position.

In some aspects, the techniques described herein relate to a shelter providing method, wherein transitioning the extendable platform includes sliding the extendable platform.

In some aspects, the techniques described herein relate to a shelter providing method, wherein the fixed platform includes a plurality of fixed platform slats, wherein the extendable platform includes a plurality of extendable platform slats, the plurality of fixed platform slats and the plurality of extendable platform slats alternate along a longitudinal axis of the roof rack assembly when the extendable platform is in the retracted position.

In some aspects, the techniques described herein relate to a shelter providing method, wherein the plurality of extendable platform slats extend outward from between adjacent fixed platform slats within the plurality of fixed platform slats when the extendable platform is in the extended position.

In some aspects, the techniques described herein relate to a shelter providing method, further including supporting a user directly on the plurality of extendable platform slats, the plurality of fixed platform slats, or both.

In some aspects, the techniques described herein relate to a shelter providing method, further including, at least partially supporting the extendable platform with a support structure when the extendable platform is in the extended position.

In some aspects, the techniques described herein relate to a shelter providing method, wherein the support structure is a ladder.

In some aspects, the techniques described herein relate to a shelter providing method, wherein the tent covers both the extendable platform and the fixed platform when the extendable platform is in the extended position.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a vehicle with a roof rack assembly having an extendable platform in an extended position and a tent secured to the roof rack assembly to provide a shelter.

FIG. 2 illustrates a perspective view of the vehicle of FIG. 1 with the tent removed and the extendable platform in a retracted position with the roof rack carrying cargo.

FIG. 3 illustrates a perspective view of the roof rack of FIGS. 1 and 2 with the tent removed and the extendable platform in the retracted position.

FIG. 3A illustrates a close-up view of an area of FIG. 3.

FIG. 3B illustrates a section view taken at line 3-3 in FIG. 3A.

FIG. 4 illustrates the roof rack of FIG. 3 with the extendable platform transitioned to the extended position.

FIG. 4A illustrates a close-up view of an area of FIG. 4.

FIG. 4B illustrates a section view taken at line 4-4 in FIG. 4A.

### DETAILED DESCRIPTION

This disclosure details exemplary shelter systems and shelter providing methods that utilize a roof rack assembly of vehicle. The roof rack assembly includes an extendable platform and a fixed platform. The extendable platform can be transitioned to an extended position relative to a fixed platform of the roof rack. The roof rack, with the extendable platform in the extended position, can be at least partially covered by a tent to provide a shelter for a user. The extendable platform in the extended position provides additional area for the user. These and other features of the exemplary embodiments are discussed below.

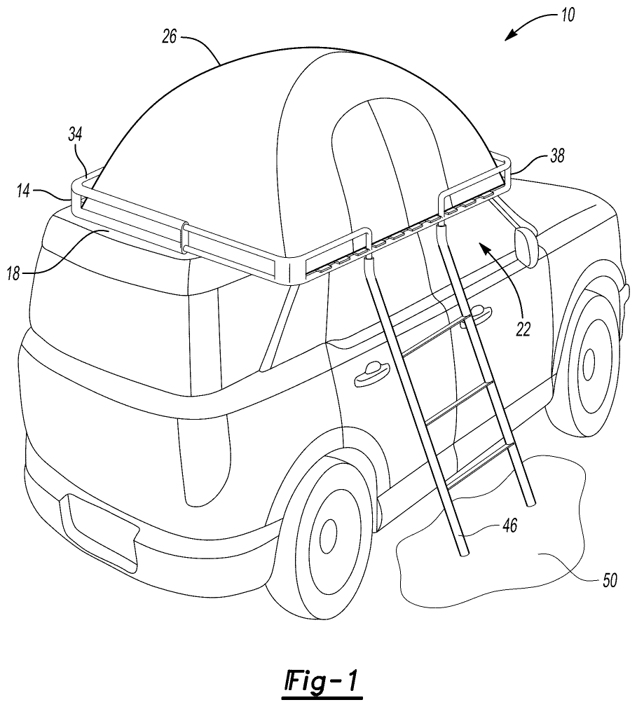

With reference to FIG. 1-4B, a vehicle 10 includes a roof rack assembly 14 mounted to a roof 18 of the vehicle 10. The vehicle 10 includes a passenger compartment 22. The roof 18 is above the passenger compartment 22. A tent 26 is secured to the roof rack assembly 14 to provide a shelter for a user.

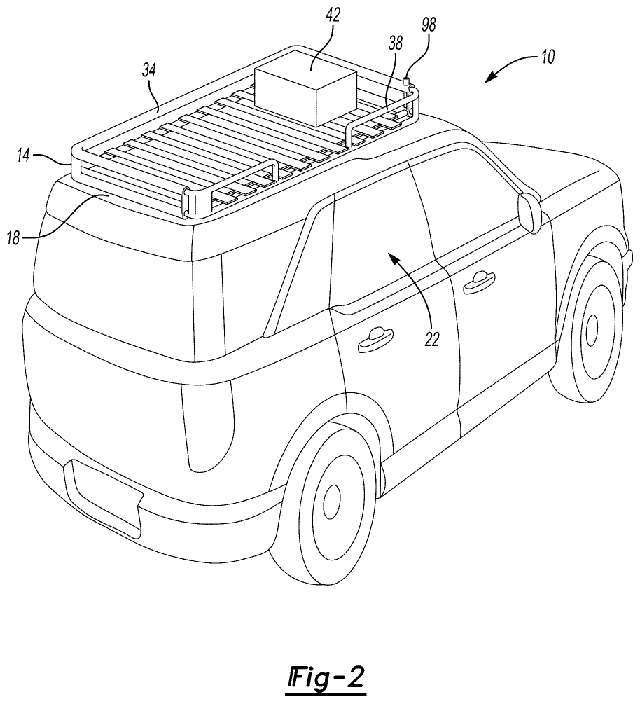

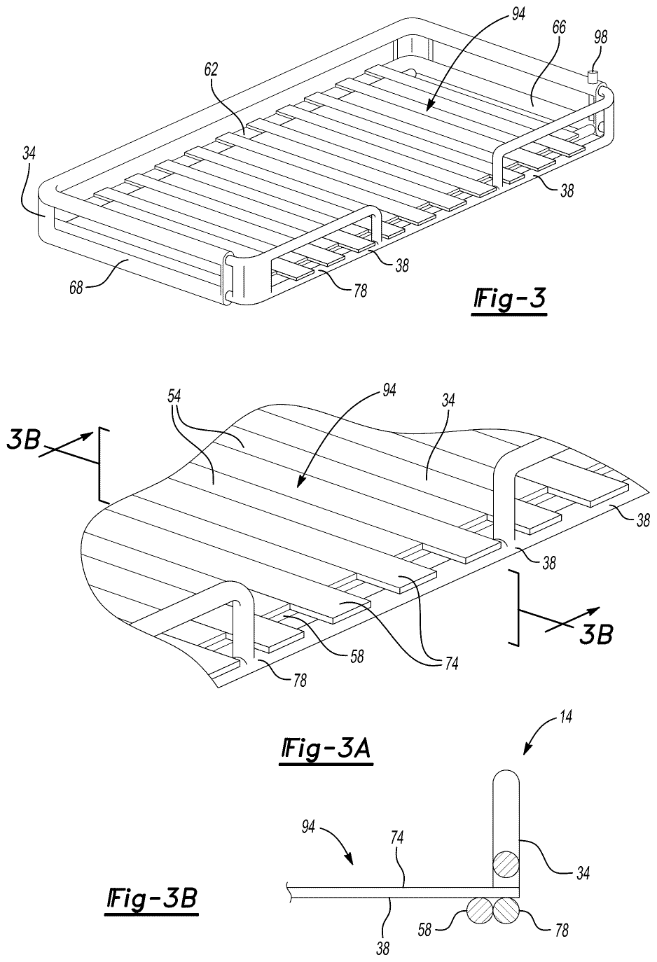

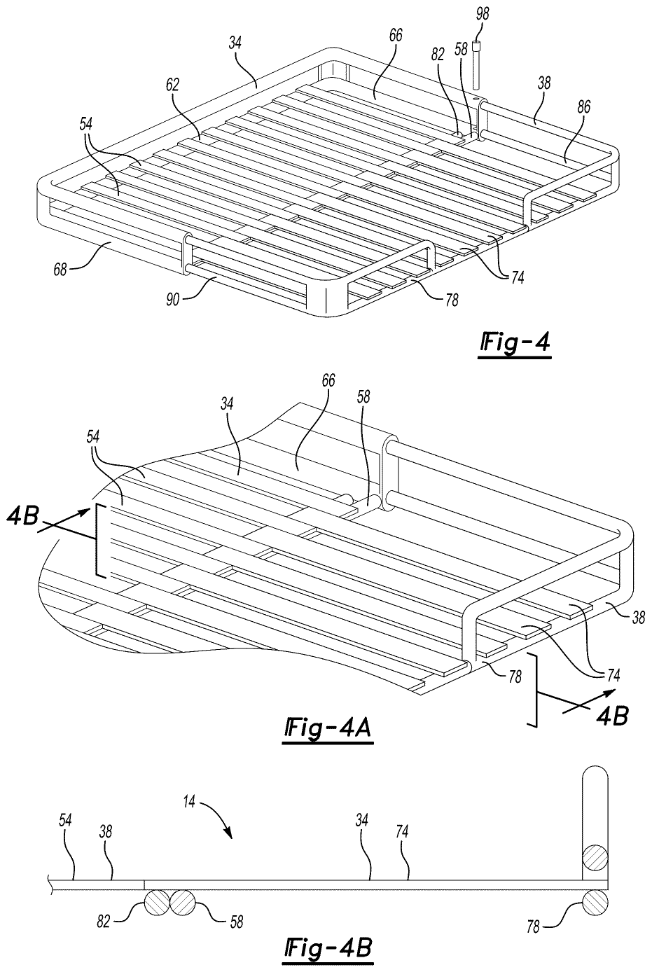

The roof rack assembly 14 includes a fixed platform 34 and an extendable platform 38. The extendable platform 38 can transition relative to the fixed platform 34 back-and-forth between an extend position as shown in FIGS. 1, 4-4B and a retracted position as shown in FIGS. 2, 3-3B.

During ordinary operation of the vehicle 10 when a shelter system is not desired, the extendable platform 38 remains in the retracted position. When the extendable platform 38 is in the retracted position, the fixed platform 34 and the extendable platform 38 together can support cargo 42 as the vehicle 10 is driven, or when the vehicle 10 is parked and is in a stationary position.

When a shelter system is desired, the vehicle 10 can be locked in a stationary position. The vehicle 10 can be locked in the stationary position by moving the gear shift to a parking position.

When the vehicle 10 is locked in a stationary position, and only when the vehicle 10 is locked in a stationary position, the extendable platform 38 can be transitioned to the extended position relative to the fixed platform 34. In this example, transitioning the extendable platform 38 to the extended position involves sliding the extendable platform 38 relative to the fixed platform 34. When transitioning, the example extendable platform 38 slides in a horizontal direction such that the extendable platform 38 overhangs a horizontally facing side of the vehicle 10 and projects outward past a perimeter of the roof 18. The example extendable platform 38 overhangs a passenger side of the vehicle 10. The extendable platform 38 could instead or additionally overhang another side of the vehicle 10 in another example.

A support structure 46, which is a ladder in this example, can be attached to the extendable platform 38. The support structure 46 extend vertically downward from the extendable platform 38 to a surface 50—here the ground. Vertical and horizontal are, for purposes of this disclosure, are with reference to the ground and a general orientation of the vehicle 10.

The user can then, with the extendable platform 38 in the extended position, secure the tent 26 to the roof rack assembly 14. The user may utilize the support structure 46 to access areas of the roof rack assembly 14 when securing the tent 26. The tent 26 can be clipped or tied to the roof rack assembly 14, the vehicle 10, or secured in some other way. With the tent 26 secured, the user can utilize the tent 26 as a shelter. The roof rack assembly 14 provides a floor of the shelter.

The example fixed platform 34 includes a plurality of fixed platform slats 54 spanning between a first fixed platform siderail 58 and a second fixed platform siderail 62. In this example, the first fixed platform siderail 58 is on a passenger side of the vehicle 10, and the second fixed platform siderail 62 is on a driver side of the vehicle 10.

The fixed platform 34 further includes a first fixed platform telescoping rail 66 and a second fixed platform telescoping rail 68. The first fixed platform telescoping rail 66 is at a forward end of the fixed platform 34 and connects to both the first fixed platform siderail 58 and the second fixed platform siderail 62. The second fixed platform telescoping rail 68 is disposed at an aft end of the fixed platform 34 and connects to both the first fixed platform siderail 58 and the second fixed platform siderail 62. Forward and aft are, for purposes of this disclosure, with reference to an orientation of the vehicle 10.

The extendable platform 38 includes a plurality of extendable platform slats 74 that span between a first extendable platform siderail 78 and a second extendable platform siderail 82. In this example, the first extendable platform siderail 78 is on a passenger side of the vehicle 10, and the second extendable platform siderail 82 is on a driver side of the vehicle 10.

The extendable platform 38 further includes at least one first extendable platform telescoping rail 86 and at least one second extendable platform telescoping rail 90. The first extendable platform telescoping rail 86 is disposed on a forward side of the extendable platform 38 and is connected to both the first extendable platform siderail 78 and the second extendable platform siderail 82. The second extendable platform telescoping rail 90 is disposed at an aft end of the extendable platform 38 and is connected to both the first extendable platform siderail 78 and the second extendable platform siderail 82.

When the extendable platform 38 of the example roof rack assembly 14 is in the retracted position, the plurality of fixed platform slats 54 and the plurality of extendable platform slats 74 are arranged in an alternating fashion along a longitudinal axis A of the roof rack assembly 14. The fixed platform slats 54 and the extendable platform slats 74 are, in this example, nearly in contact with each other when the extendable platform 38 is in the retracted position, which provides the roof rack assembly 14 with a support surface 94 that is substantially continuous. Cargo C can be supported upon the support surface 94.

The first extendable platform telescoping rail 86 is received within the first fixed platform telescoping rail 66. The second extendable platform telescoping rail 90 is telescopically received within the second fixed platform telescoping rail 68. To transition the extendable platform 38 to the extended position, a user can, for example, disengage a latch 98 and then pull on the first extendable platform siderail 78. The pulling withdraws the first extendable platform telescoping rail 86 from within the first fixed platform telescoping rail 66, and the second extendable platform telescoping rail 90 from within the second fixed platform telescoping rail 68. Pulling on the first extendable platform siderail 78 also pulls the extendable platform slats 74 outward from between the fixed platform slats 54.

The first extendable platform siderail 78 is pulled out by the user until the extendable platform 38 is in the position of FIGS. 1 and 4-4B. The user can then attach the support structure 46, which again is the ladder in this example, and then secure the tent 26 to the roof rack assembly 14 with the extendable platform 38 in the extended position.

When the extendable platform 38 is in the extended position, the fixed platform slats 54 and the extendable platform slats 74 are still disposed in an alternating fashion along the axis A, yet the extendable platform slats 74 are shifted outward relative to the fixed platform slats 54 and a centerline of the vehicle 10. This leaves gaps between the fixed platform slats 54, and gaps between the extendable platform slats 74.

With the extendable platform 38 in the extended position, the fixed platform slats 54 and the extendable platform slats 74 can directly support one or more users. The vehicle 10 can not be moved from the stationary position unless and until the extendable platform 38 has been transitioned back to the retracted position of FIGS. 2 and 3. The user can push the extendable platform 38 back toward the centerline of the vehicle 10 to transition the extendable platform 38 back to the fixed position.

In this example, when transitioning the extendable platform 38 to the extended position, the extendable platform slats 74 slide over a top surface of the first fixed platform siderail 58.

In another example, the first fixed platform siderail 58 could include a series of apertures. Each of the extendable platform slats 74 could be received within those apertures of the first fixed platform siderail 58 and slide within the apertures as the extendable platform 38 is transitioned to the extended position. Receipt of the extendable platform slats 74 within the apertures can help, in some examples, to guide the extendable platform slats 74 as the extendable platform 38 is extended and to stabilize the extendable platform slats 74 when supporting a user with the extendable platform 38 in the extend position.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A shelter system for a vehicle, comprising:
a roof rack assembly having a fixed platform and an extendable platform, the extendable platform configured to transition back-and-forth between a retracted position relative to the fixed platform and an extended position relative to the fixed platform, the extendable platform projecting outward away from a vehicle roof when the extendable platform is in extended position; and
a tent that covers the roof rack assembly when the extendable platform is in the extended position.

2. The shelter system of claim 1, wherein the extendable platform projects outward past a side of a vehicle when the extendable platform is in the extended position.

3. The shelter system of claim 1, wherein the fixed platform includes a plurality of fixed platform slats, wherein the extendable platform includes a plurality of extendable platform slats, the plurality of fixed platform slats and the plurality of extendable platform slats alternate along a longitudinal axis of the roof rack assembly when the extendable platform is in the retracted position.

4. The shelter system of claim 3, wherein the extendable platform slats extend outward from between adjacent fixed platform slats within the plurality of fixed platform slats when the extendable platform is in the extended position.

5. The shelter system of claim 4, wherein the extendable platform projects outward past a perimeter of a roof of a vehicle when the extendable platform is in the extended position.

6. The shelter system of claim 3, wherein the plurality of fixed platform slats span between a first fixed platform siderail of the roof rack assembly and a second fixed platform siderail of the roof rack assembly, wherein the plurality of extendable platform slats span between a first extendable platform siderail and a second extendable platform siderail, wherein the first and second extendable platform siderails move with the plurality of extendable platform slats back-and-forth between the retracted position and the extended position.

7. The shelter system of claim 6, wherein the plurality of extendable platform slats are each received within a corresponding aperture of the first fixed platform siderail and are configured to slide within the apertures relative to the first fixed platform siderail when the extendable platform is transitioned back-and-forth between the retracted position and the extended position.

8. The shelter system of claim 6, wherein the first fixed platform siderail is on a driver side of the roof rack assembly and the second fixed platform siderail is on a passenger side of the roof rack assembly.

9. The shelter system of claim 6, further comprising a first fixed platform telescoping rail, a second fixed platform telescoping rail, a first extendable platform telescoping rail, and a second extendable platform telescoping rail,
the first fixed platform telescoping rail spanning between the first and the second fixed platform siderails on a first side of the roof rack assembly,
the second fixed platform telescoping rail spanning between the first and the second fixed platform siderails on an opposite second side of the roof rack assembly,
the first extendable platform telescoping rail spanning between the first and the second extendable platform siderails on the first side of the roof rack assembly,
the second extendable platform telescoping rail spanning between the first and the second extendable platform siderails on the second side of the roof rack assembly,
the first extendable platform telescoping rail received within the first fixed platform telescoping rail and configured to extend and retract relative to the first fixed platform telescoping rail when the extendable platform is transitioned back-and-forth between the retracted position and the extended position,
the second extendable platform telescoping rail received within the second fixed platform telescoping rail and configured to extend and retract relative to the second fixed platform telescoping rail when the extendable platform is transitioned back-and-forth between the retracted position and the extended position.

10. The shelter system of claim 3, wherein the plurality of fixed platform slats and the plurality of extendable platform slats are configured to directly support a user positioned within the tent when the extendable platform is in the extended position.

11. The shelter system of claim 1, further comprising a support structure attachable to the extendable platform and configured to extend from a surface to the extendable platform to support the extendable platform when the extendable platform is in the extended position.

12. The shelter system of claim 11, wherein the support structure is a ladder.

13. A shelter providing method, comprising:
transitioning an extendable platform of a roof rack assembly from a retracted position to an extended position relative to a fixed platform of the roof rack assembly, the extendable platform overhanging a vehicle roof when in the extended position; and
positioning a tent on the roof rack assembly when the extendable platform is in the extended position.

14. The shelter providing method of claim 13, wherein transitioning the extendable platform comprises sliding the extendable platform.

15. The shelter providing method of claim 13, wherein the fixed platform includes a plurality of fixed platform slats, wherein the extendable platform includes a plurality of extendable platform slats, the plurality of fixed platform slats and the plurality of extendable platform slats alternate along a longitudinal axis of the roof rack assembly when the extendable platform is in the retracted position.

16. The shelter providing method of claim 15, wherein the plurality of extendable platform slats extend outward from between adjacent fixed platform slats within the plurality of fixed platform slats when the extendable platform is in the extended position.

17. The shelter providing method of claim 15, further comprising supporting a user directly on the plurality of extendable platform slats, the plurality of fixed platform slats, or both.

18. The shelter providing method of claim 13, further comprising, at least partially supporting the extendable platform with a support structure when the extendable platform is in the extended position.

19. The shelter providing method of claim 18, wherein the support structure is a ladder.

20. The shelter providing method of claim 13, wherein the tent covers both the extendable platform and the fixed platform when the extendable platform is in the extended position.
